(19) United States
(12) Patent Application Publication
(10) Pub. No.: US 2015/0321155 A1
(43) Pub. Date: Nov. 12, 2015

(54) FUEL DELIVERY SYSTEM AND METHOD OF OPERATING A POWER GENERATION SYSTEM

(71) Applicant: General Electric Company, Schenectady, NY (US)

(72) Inventors: Kihyung Kim, Atlanta, GA (US); Leslie Yung-Min Tong, Roswell, GA (US)

(73) Assignee: General Electric Company, Schenectady, NY (US)

(21) Appl. No.: 14/274,894

(22) Filed: May 12, 2014

(51) Int. Cl. B01F 15/02; B01F 3/02; C01B 3/38; C10L 3/06; C10K 3/06; F02C 7/22; B01F 15/06

(52) U.S. Cl. CPC B01F 15/0243; F02C 7/22; B01F 3/026; B01F 15/065; C10L 3/06; C10K 3/06; C01B 3/38; C10L 2290/06; C10L 2290/24; C10L 2290/58; C01B 2203/0227; C01B 2203/062; C01B 2203/1671; C01B 2203/1241

(57) ABSTRACT

A fuel delivery system is provided. The system includes a natural gas reformer configured to receive a flow of natural gas and a flow of air. The natural gas reformer combines the natural gas and the air in a reaction to produce a flow of reformate gas. The system also includes a mixing device coupled downstream from the natural gas reformer. The mixing device is configured to selectively mix amounts of the reformate gas, vaporized liquid fuel, and natural gas to produce a flow of mixed product fuel having predetermined operating parameters.

### BACKGROUND

The present disclosure relates generally to turbine engines and, more particularly, to systems and methods of producing fuel from various fuel sources for use in turbine engines.

Rotary machines, such as gas turbines, are often used to generate power with electric generators. Gas turbines, for example, have a gas path that typically includes, in serial-flow relationship, an air intake, a compressor, a combustor, a turbine, and a gas outlet. Compressor and turbine sections include at least one row of circumferentially-spaced rotating buckets or blades coupled within a housing. At least some known turbine engines are used in cogeneration facilities and power plants. Engines used in such applications may have high specific work and power per unit mass flow requirements. To increase operating efficiency, at least some known gas turbine engines may operate at increased combustion temperatures.

While operating known turbine engines at higher temperatures generally increases operating efficiency, higher temperatures may also increase the generation of polluting emissions, such as oxides of nitrogen (NOₓ). At least some known fuel injection assemblies attempt to reduce emissions, such as NOₓ and carbon monoxide, by using pre-mixing technology in combination with Dry Low NOₓ (DLN) combustion systems. For example, at least some known DLN combustion systems include multiple premix fuel circuits and/or fuel nozzles that reduce NOₓ emissions at a given cycle temperature. Pre-mixing the fuel and air facilitates controlling the temperature of the combustion gases such that the operating temperature does not rise above a threshold where NOₓ emissions are formed. Moreover, at least some known DLN combustion systems utilize a blend of hydrogen and natural gas as fuel. Such hydrogen doping of the fuel channeled towards the combustor has been shown to reduce emission levels and to reduce a likelihood of combustor lean blow out (LBO). The hydrogen is generally produced from natural gas in known reforming processes. As such, it would be advantageous to increase the efficiency of power generation systems implementing known reforming processes.

### BRIEF DESCRIPTION

In one aspect, a fuel delivery system is provided. The system includes a natural gas reformer configured to receive a flow of natural gas and a flow of air. The natural gas reformer combines the natural gas and the air in a reaction to produce a flow of reformate gas. The system also includes a mixing device coupled downstream from the natural gas reformer. The mixing device is configured to selectively mix amounts of the reformate gas, vaporized liquid fuel, and natural gas to produce a flow of mixed product fuel having predetermined operating parameters.

In another aspect, a turbine engine is provided. The turbine engine includes a compressor configured to discharge a flow of compressor discharge air, a natural gas reformer configured to receive a flow of natural gas and a flow of air therein, and an inlet conditioning subsystem coupled upstream from the natural gas reformer. The inlet conditioning subsystem is configured to receive the flow of compressor discharge air, and modify operating conditions of the compressor discharge air prior to discharging the flow of air towards the natural gas reformer.

In yet another aspect, a method of operating a power generation system is provided. The method includes channeling a flow of compressor discharge air towards an inlet conditioning subsystem, modifying operating conditions of the compressor discharge air to produce a flow of reformer inlet air, and channeling the flow of reformer inlet air towards a natural gas reformer coupled upstream from the turbine engine.

### BRIEF DESCRIPTION OF THE DRAWINGS

FIG. 1 is a schematic illustration of an exemplary gas turbine power system.

FIG. 2 is a schematic illustration of an alternative inlet conditioning system that may be used with the gas turbine power system shown in FIG. 1.

### DETAILED DESCRIPTION

Embodiments of the present disclosure relate to reforming systems that may be used in producing fuel to be used in a turbine engine. The reforming systems described herein use compressor discharge air to facilitate improving the efficiency of a natural gas reformer and its associated overall power generation system. For example, the compressor discharge air may be either cooled and directly channeled towards the natural gas reformer, or the air may be utilized to preheat a flow of natural gas channeled towards the natural gas reformer. Also described herein is a fuel delivery subsystem that facilitates providing a multi-component product fuel to be channeled towards a combustor of the power generation system. Specifically, the fuel delivery subsystem mixes natural gas, reformate gas, and vaporized liquid fuel to produce a fuel having predetermined operating parameters. As such, the systems and methods described herein facilitate the use of relatively low-weight (e.g., C2-C6) hydrocarbons in known Dry Low NOₓ combustion systems, and/or heavier-weight hydrocarbons in other known combustion systems.

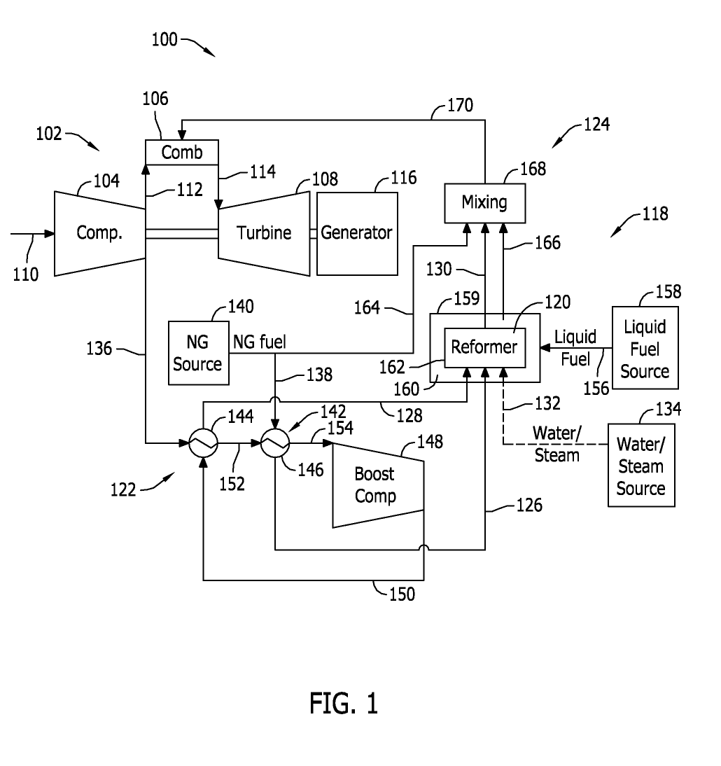

FIG. 1 is a schematic illustration of an exemplary gas turbine power generation system 100. In the exemplary embodiment, gas turbine power generation system 100 includes a turbine engine assembly 102 that includes an axial flow compressor 104, a combustor 106, and a gas turbine 108. Intake air 110 is directed towards axial flow compressor 104, and compressed air 112 is directed towards combustor 106 where fuel is injected with compressed air 112 for combustion purposes. Hot gas 114 is discharged from combustor 106 and is directed towards gas turbine 108 where the thermal energy of hot gas 114 is converted to work. A portion of the work is used to drive compressor 104, and the balance is used to drive an electric generator 116 to generate electric power. A hot exhaust gas mixture (not shown) is discharged from gas turbine 108 and channeled to either the atmosphere or to a Heat Recovery Steam Generator (HRSG) (not shown).

Gas turbine power generation system 100 also includes a reforming system 118 that facilitates producing fuel to be used by combustor 106. Reforming system 118 includes a natural gas reformer 120, an inlet conditioning subsystem 122 coupled upstream from natural gas reformer 120, and a fuel delivery subsystem 124 coupled downstream from natural gas reformer 120. In the exemplary embodiment, natural gas reformer 120 is a catalytic partial oxidation reactor (not shown) that facilitates converting methane and oxygen to carbon monoxide and hydrogen. Alternatively, natural gas reformer 120 may be any exothermic reformer that enables gas turbine power generation system 100 to function as described herein.

In operation, natural gas reformer 120 receives a flow of reformer inlet natural gas 126 and a flow of reformer inlet air 128 from inlet conditioning subsystem 122. Specifically, and as will be described in more detail below, inlet conditioning subsystem 122 facilitates modifying operating conditions of reformer inlet natural gas 126 and reformer inlet air 128 before being channeled towards natural gas reformer 120. As such, natural gas reformer 120 receives reformer inlet natural gas 126 and reformer inlet air 128 to produce a flow of reformate gas 130 in the following reaction:

CH₄+1/2O₂→2H₂+CO

In an alternative embodiment, natural gas reformer 120 receives a flow of water/steam 132 from a water/steam source 134 to facilitate reducing a temperature within natural gas reformer 120 and causing it to act as an autothermal reformer (not shown).

Inlet conditioning subsystem 122 is coupled downstream from compressor 104 and receives a flow of compressor discharge air 136 therefrom. Inlet conditioning subsystem 122 also receives a first flow of natural gas 138 from a natural gas source 140. Inlet conditioning subsystem 122 includes a plurality of heat exchangers 142 coupled together in a semi-closed loop configuration (not shown) to facilitate producing reformer inlet natural gas 126 and reformer inlet air 128 to be channeled towards natural gas reformer 120. For example, the operating conditions (i.e., temperature and/or pressure) of compressor discharge air 136 and/or natural gas 138 are modified to ensure gas turbine power generation system 100 operates normally. As such, arranging the plurality of heat exchangers 142 in the semi-closed loop configuration facilitates minimizing heat loss from compressor discharge air 136 as it is channeled through inlet conditioning subsystem 122. In an alternative embodiment, a flow of ambient air (not shown) bypasses inlet conditioning subsystem 122 and is channeled towards natural gas reformer 120.

In the exemplary embodiment, inlet conditioning subsystem 122 includes a first heat exchanger 144, a second heat exchanger 146 coupled downstream from first heat exchanger 144, and a booster compressor 148 coupled downstream from second heat exchanger 146. First heat exchanger 144 receives compressor discharge air 136 and a flow of recycled air 150 from booster compressor 148, and discharges reformer inlet air 128 and a flow of cooled compressor discharge air 152 therefrom. Specifically, heat is transferred between compressor discharge air 136 and recycled air 150 to facilitate producing reformer inlet air 128. As such, a temperature of compressor discharge air 136 is reduced to facilitate reaching a predetermined inlet temperature threshold for booster compressor 148, and a temperature of recycled air 150 is increased such that a temperature of reformer inlet air 128 is less than the temperature of compressor discharge air 136. Moreover, booster compressor 148 pressurizes recycled air 150 such that a pressure of reformer inlet air 128 reaches a predetermined inlet pressure threshold for natural gas reformer 120.

Second heat exchanger 146 (i.e., a trim cooler) receives cooled compressor discharge air 152 and natural gas 138 from natural gas source 140, and discharges reformer inlet natural gas 126 and a flow of booster compressor inlet air 154 therefrom. Specifically, heat is transferred between cooled compressor discharge air 152 and natural gas 138 to facilitate producing reformer inlet natural gas 126. As such, a temperature of cooled compressor discharge air 152 is further reduced such that booster compressor inlet air 154 at least reaches the predetermined inlet temperature threshold for booster compressor 148, and a temperature of reformer inlet natural gas 126 is increased to facilitate preheating reformer inlet natural gas 126 before being channeled towards natural gas reformer 120. Preheating reformer inlet natural gas 126 facilitates reducing fuel consumption in natural gas reformer 120.

As described above, natural gas reformer 120 receives reformer inlet natural gas 126 and reformer inlet air 128 to produce reformate gas 130. The reaction within natural gas reformer 120 that facilitates converting methane and oxygen to carbon monoxide and hydrogen is highly exothermic. As such, heat generated from the exothermic reaction is utilized to facilitate vaporizing a flow of liquid fuel 156 channeled from a liquid fuel source 158. Exemplary liquid fuels include, but are not limited to, liquefied petroleum gas, diesel, gasoline, and/or higher molecular weight hydrocarbon (i.e., C5+ hydrocarbons) fuels.

In the exemplary embodiment, an enclosure 159 is positioned about natural gas reformer 120 to facilitate vaporizing liquid fuel 156. Enclosure 159 includes an internal cavity 160 sized to receive natural gas reformer 120. Liquid fuel 156 is channeled past a thermally conductive outer surface 162 of natural gas reformer 120 to facilitate transferring heat generated by the exothermic reaction to liquid fuel 156. As such, a flow of vaporized liquid fuel 166 is produced and channeled downstream from natural gas reformer 120 for combustion purposes. In an alternative embodiment, liquid fuel 156 is combined directly with reformate gas 130 discharged from reformer 120 to facilitate vaporizing liquid fuel 156.

Fuel delivery subsystem 124 is coupled downstream from natural gas reformer 120 and receives a second flow of natural gas 164, reformate gas 130, and vaporized liquid fuel 166. Specifically, fuel delivery subsystem 124 includes a mixing device 168 coupled downstream from natural gas reformer 120. Mixing device 168 selectively mixes amounts of natural gas 164, reformate gas 130, and vaporized liquid fuel 166 to produce a flow of mixed product fuel 170 capable of being channeled directly towards combustor 106. The amounts of natural gas 164, reformate gas 130, and vaporized liquid fuel 166 are selected such that mixed product fuel 170 has predetermined operating parameters required by combustor 106 to function properly. Exemplary operating parameters include, but are not limited to, temperature, composition, and/or Modified Wobbe Index. Mixing device 168 facilitates controlling the operating parameters of mixed product fuel 170 by controlling the ratio of natural gas 164, reformate gas 130, and vaporized liquid fuel 166 in mixed product fuel 170. For example, the operating parameters are controlled as a function of a natural gas split ratio between the first and second flows of natural gas 138 and 164, a ratio of natural gas 164 and vaporized liquid fuel 166 channeled towards mixing device 168, and/or a ratio of reformer inlet natural gas 126 and reformer inlet air 128 channeled towards natural gas reformer 120. As such, mixing device 168 ensures each operating parameter of mixed product fuel 170 is within a predetermined threshold before being channeled towards combustor 106.

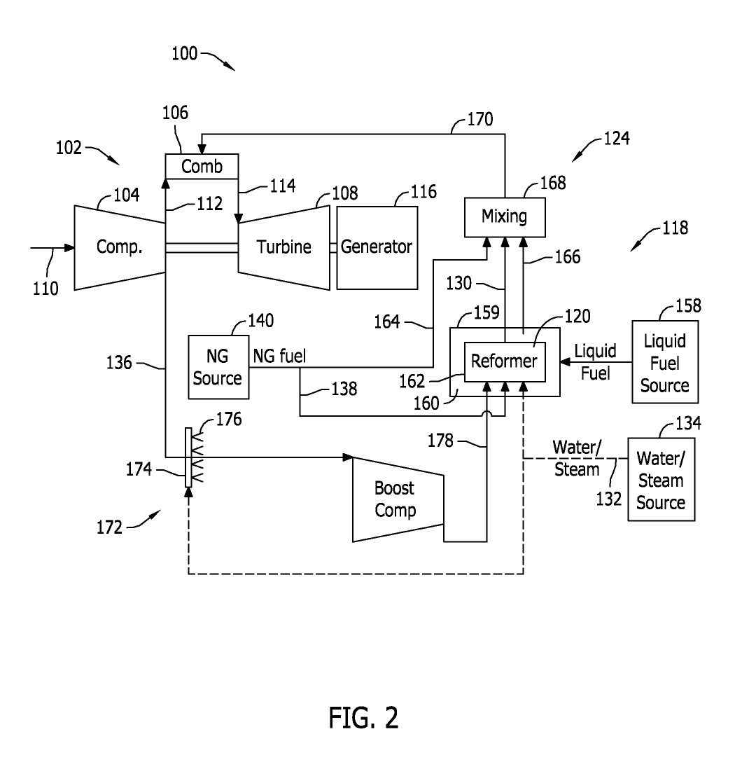

FIG. 2 is a schematic illustration of an alternative inlet conditioning subsystem 172 that may be used with reforming system 118. In the exemplary embodiment, inlet conditioning subsystem 172 includes a nozzle array 174 coupled upstream from booster compressor 148. Nozzle array 174 is coupled in flow communication with the flow of compressor discharge air 136, and discharges cooling fluid 176, such as water and/or steam, towards compressor discharge air 136. Nozzle array 174 at least partially saturates compressor discharge air 136 with cooling fluid 176 to facilitate reducing a temperature of compressor discharge air 136 before being channeled towards booster compressor 148. Booster compressor 148 then channels a flow of booster compressor discharge air 178 towards natural gas reformer 120. Moreover, in the exemplary embodiment, the first flow of natural gas 138 is channeled directly towards natural gas reformer 120 from natural gas source 140.

The systems and methods described herein facilitate enabling the use of compressor discharge air as a reactant in a natural gas reformer, and facilitate producing a multi-component product fuel to be channeled towards a combustor of the power generation system. In the exemplary embodiment, the system includes a natural gas reformer, an inlet conditioning subsystem positioned upstream from the natural gas reformer, and a fuel delivery subsystem coupled downstream from the natural gas reformer. The inlet conditioning subsystem ensures reactants fed to the natural gas reformer are at the proper operating conditions, and the fuel delivery subsystem facilitates enabling the use of vaporized liquid fuel in a combustor of the turbine engine. As such, the auxiliary subsystems described herein facilitate enhancing the efficiency and versatility of the natural gas reformer.

This written description uses examples to disclose the embodiments of the present disclosure, including the best mode, and also to enable any person skilled in the art to practice embodiments of the present disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A fuel delivery system comprising:
a natural gas reformer configured to receive a flow of natural gas and a flow of air, said natural gas reformer combining the natural gas and the air in a reaction to produce a flow of reformate gas; and
a mixing device coupled downstream from said natural gas reformer, said mixing device configured to selectively mix amounts of the reformate gas, vaporized liquid fuel, and natural gas to produce a flow of mixed product fuel having predetermined operating parameters.

2. The system in accordance with claim 1, wherein said mixing device selectively mixes the reformate gas, the vaporized liquid fuel, and the natural gas to produce the flow of mixed product fuel having predetermined operating parameters including at least one of temperature, composition, or Modified Wobbe Index.

3. The system in accordance with claim 1 further comprising an enclosure comprising an internal cavity sized to receive said natural gas reformer, said internal cavity sized to channel a flow of liquid fuel therethrough, wherein said natural gas reformer reacts the natural gas and the air in an exothermic reaction that generates heat utilized to vaporize the flow of liquid fuel.

4. The system in accordance with claim 3, wherein said enclosure is configured to channel the flow of liquid fuel past a thermally conductive outer surface of said natural gas reformer to facilitate transferring the heat to the liquid fuel.

5. The system in accordance with claim 1, wherein said mixing device is configured to control a ratio of the reformate gas, the vaporized liquid fuel, and the natural gas in the mixed product fuel to ensure the mixed product fuel has the predetermined operating parameters.

6. The system in accordance with claim 1 further comprising a natural gas source configured to channel a the flow of natural gas directly towards said mixing device.

7. The system in accordance with claim 1, wherein said mixing device channels the flow of mixed product fuel directly towards a combustor of the turbine engine.

8. A turbine engine comprising:
a compressor configured to discharge a flow of compressor discharge air;
a natural gas reformer configured to receive a flow of natural gas and a flow of air therein; and
an inlet conditioning subsystem coupled upstream from said natural gas reformer, said inlet conditioning subsystem configured to:
receive the flow of compressor discharge air; and
modify operating conditions of the compressor discharge air prior to discharging the flow of air towards said natural gas reformer.

9. The turbine engine in accordance with claim 8, wherein said inlet conditioning subsystem comprises a plurality of heat exchangers configured to modify operating conditions of at one of the compressor discharge air and a second flow of natural gas channeled towards said inlet conditioning subsystem.

10. The turbine engine in accordance with claim 9, wherein said plurality of heat exchangers are coupled together in a semi-closed loop configuration.

11. The turbine engine in accordance with claim 9, wherein said plurality of heat exchangers comprise:
a first heat exchanger configured to reduce a temperature of the compressor discharge air prior to discharging the flow of air towards said natural gas reformer; and
a second heat exchanger coupled downstream from said first heat exchanger, said second heat exchanger configured to preheat the second flow of natural gas prior to discharging the flow of natural gas towards said natural gas reformer.

12. The turbine engine in accordance with claim 11 further comprising a booster compressor coupled downstream from said second heat exchanger, said booster compressor configured to channel a flow of recycle air towards said first heat exchanger.

13. The turbine engine in accordance with claim 8, wherein said inlet conditioning subsystem comprises a nozzle array configured to discharge cooling fluid towards the flow of compressor discharge air.

14. The turbine engine in accordance with claim 13, wherein said inlet conditioning subsystem comprises a booster compressor coupled downstream from said nozzle array, said booster compressor configured to pressurize the flow of air prior to the flow of air being channeled towards said natural gas reformer.

15. A method of operating a power generation system, said method comprising:
channeling a flow of compressor discharge air towards an inlet conditioning subsystem;
modifying operating conditions of the compressor discharge air to produce a flow of reformer inlet air; and
channeling the flow of reformer inlet air towards a natural gas reformer coupled upstream from the turbine engine.

16. The method in accordance with claim 15, wherein modifying operating conditions of the compressor discharge air comprises modifying at least one of a temperature or a pressure of the compressor discharge air.

17. The method in accordance with claim 15 further comprising:
channeling a flow of reformer inlet natural gas towards the natural gas reformer; and
reacting the reformer inlet air and the reformer inlet natural gas in the natural gas reformer to produce a flow of reformate gas.

18. The method in accordance with claim 17, wherein channeling a flow of reformer inlet natural gas comprises:
channeling a flow of natural gas towards the inlet conditioning subsystem; and
modifying operating conditions of the natural gas prior to discharging the reformer inlet natural gas towards the natural gas reformer.

19. The method in accordance with claim 17 further comprising:
channeling the flow of reformate gas towards a fuel delivery subsystem; and
selectively mixing the reformate gas with natural gas and vaporized liquid fuel to produce a flow of mixed product fuel having predetermined operating parameters.

20. The method in accordance with claim 19, wherein selectively mixing comprises controlling a ratio of the reformate gas, the natural gas, and the vaporized liquid fuel in the mixed product fuel to ensure the mixed product fuel has the predetermined operating parameters.
